(19) United States
(12) Patent Application Publication
(10) Pub. No.: US 2006/0196264 A1
(43) Pub. Date: Sep. 7, 2006

(54) Level sensor

(75) Inventor: Daniel Stahlmann, Williamsburg, VA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/071,853

(22) Filed: Mar. 3, 2005

(51) Int. Cl. G01F 23/24

(52) U.S. Cl. 73/304 R

(57) ABSTRACT

A level sensor device (20) is useful for making fluid level determinations of highly conductive fluids such as urea. A conductive polymer element (30) has a base polymer material and carbon powder in one example. The amount of immersion of the conductive polymer element within the fluid of interest causes a change in an electrical output from the element, which provides an indication of fluid level.

### FIELD OF THE INVENTION

This invention generally relates to level sensors. More particularly, this invention relates to a level sensor utilizing a conductive polymer sensing element.

### DESCRIPTION OF THE RELATED ART

There are a variety of situations where level detection is desirable. Vehicle fuel systems are one example. Another example is a selectively catalytic reaction vehicle engine emission control system. In such systems, urea and deionized water are stored within a tank and supplied to a catalytic converter so that the urea, which decomposes into ammonia hydroxide, effectively controls the nitrogen oxide emissions that result from engine operation. It is important for such systems to operate with an appropriate amount of fluid within the tank.

Known level sensors are not economically feasible for use on a vehicle or are not capable of operating in a harsh environment that includes a fluid such as urea. The high conductivity of urea, for example, renders most sensors unusable in such an environment.

One example sensor arrangement is shown in the German patent document DE 10047594. That sensor includes electrodes inserted into a fluid for making a fluid level determination. One shortcoming of that arrangement is that it is not capable of withstanding the harsh environment of a high conductivity fluid such as a fluid containing urea.

There is a need for a level sensor that is capable of withstanding the relatively harsh environment of a high conductivity fluid such as urea. This invention addresses that need.

### SUMMARY OF THE INVENTION

An exemplary disclosed sensor device that is useful for determining the level of a fluid within a container includes a conductive polymer element that is adapted to be at least partially immersed in the fluid. The fluid establishes a conductive path between the conductive element and ground. A controller selectively energizes the conductive polymer element and makes a level determination based upon an electrical output corresponding to a dimension of a portion of the conductive polymer element outside of the fluid.

In one example, the controller energizes the conductive polymer element with a purely AC input. Avoiding DC components avoids corrosion associated with highly conductive fluids.

In one example, the conductive polymer element comprises a polymer material and carbon powder. In one example, the carbon powder is uniformly distributed at least along a length of the conductive polymer element. One example includes a polyphthalamide polymer material.

In one example, the conductive polymer element has an electrical resistance that is much higher than an electrical resistance of the fluid. In one example, the conductive polymer element has an electrical resistance that is about 500 Kilo-Ohms.

The disclosed example is useful for making urea level determinations because the material and the manner in which the sensor is operated provide reliable measurements and a robustness that can withstand the harshness of a highly conductive fluid such as urea.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows an example level sensor arrangement designed according to an embodiment of this invention.

FIG. 2 schematically shows a powering arrangement that is useful as part of a controller in an example embodiment like that shown in FIG. 1.

FIG. 3 is a timing diagram illustrating one example technique of operating the embodiment of FIG. 2.

FIG. 4 schematically shows a sensor device including a level sensing element designed according to an embodiment of this invention.

### DETAILED DESCRIPTION OF THE PREFERRED EMBODIMENT

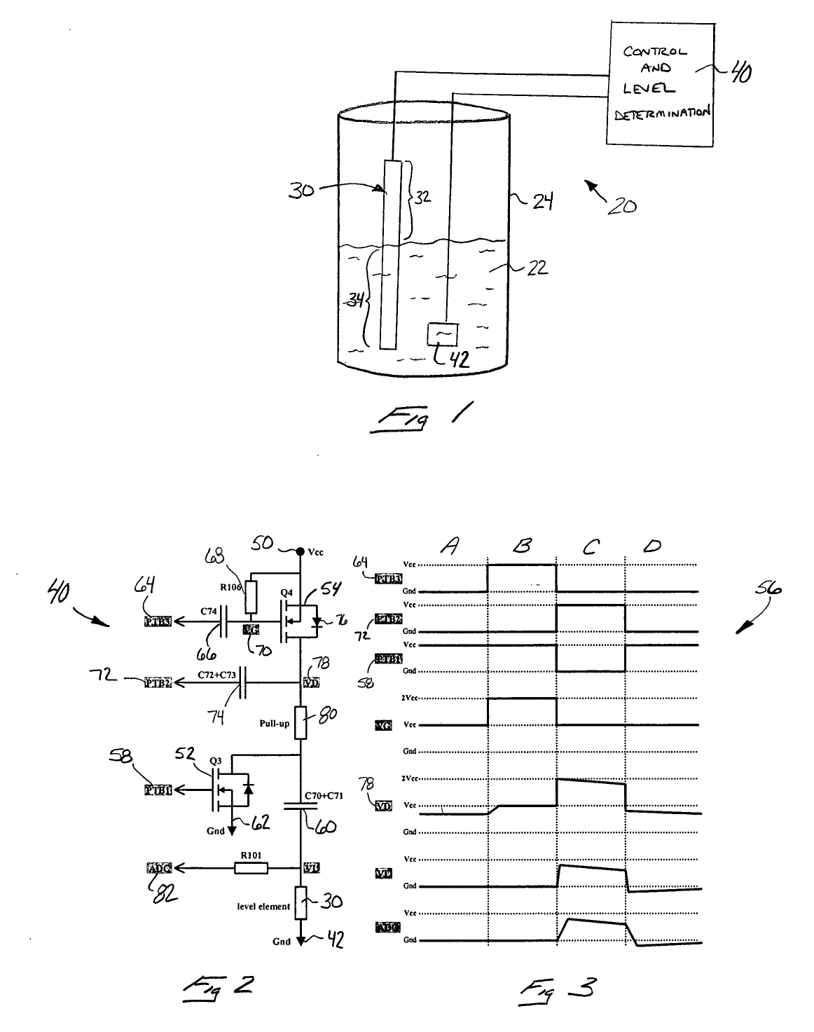

FIG. 1 schematically shows a sensor device 20 that is useful for determining a level of a fluid 22 within a container 24. In one example, the fluid 22 comprises urea and dionized water and the container 24 is part of a selectively catalytic reaction vehicle emission control system. The fluid 22 in this example is for controlling nitrogen oxide emissions that result from vehicle engine operation.

The sensor device 20 includes a conductive polymer element 30 that is adapted to be immersed in the fluid 22. The conductive polymer element 30 has material characteristics that are selected to withstand the relatively harsh environment of a highly conductive fluid such as urea.

A controller 40 selectively electrically energizes the conductive polymer element 30 for making a fluid level determination. Given this description, those skilled in the art will realize what combination of software, hardware and firmware will work for a controller to meet the needs of their particular situation. In one example, only AC electrical power energizes the conductive polymer element 30. Avoiding DC components avoids corrosion that otherwise would occur in a fluid such as urea. One advantage to the disclosed example is that it utilizes only AC electrical energy along the conductive polymer element 30 for making a fluid level determination, which avoids or at least minimizes the possibility of corrosion of the sensor device 20.

The fluid 22 establishes an electrically conductive path from the conductive polymer element 30 to ground. In the illustrated example, a grounded electrode 42 is placed within the fluid 22. In one example, as shown in FIG. 4 and described below, the grounded electrode 42 is an electrode of a capacitor used for a fluid quality determination (i.e., urea concentration).

As the controller 40 energizes the conductive polymer element 30, electrons essentially travel through the fluid 22, which has a high conductivity, to the grounded electrode 42. The level of fluid 22 affects the ability of electrons to travel to ground. As can be appreciated from FIG. 1, one portion 32 of the conductive polymer element 30 is outside of the fluid 22 while another portion 34 is immersed in the fluid 22. The dimensions of each portion vary with the fluid level. Accordingly, an electrical output from the conductive polymer element 30 provides an indication of the level of fluid 22 within the container 24. In the illustrated example, the portion 32 of the conductive polymer element 30 that is outside of the fluid 22 provides an electrical output (i.e., a voltage) that is indicative of the level of fluid 22 within a container 24. For example, a voltage indicates a resistance of the conductive polymer element 30. The resistance varies depending on the amount of fluid. As the fluid 22 surrounds more of the conductive polymer element 30, the effective resistance decreases. Accordingly, higher resistance measurements will correspond to a lower fluid level while lower resistance measurements (i.e., lower voltage outputs) corresponds to a larger amount or higher level of the fluid 22 within the container 24.

Known techniques for relating an electrical output such as a voltage from the conductive polymer element 30 to a fluid level are used in one example. Given this description, those skilled in the art will be able to select a known technique for relating such an electrical output to a fluid level, for example, by empirically determining corresponding fluid levels and voltage levels for a chosen energization strategy and a given container configuration.

In one example, the conductive polymer element 30 comprises a polymer material and carbon powder. The carbon powder preferably is uniformly distributed at least along the length of the conductive polymer element 30 to provide a consistent, reliable electrical output corresponding to a level of fluid. The uniform distribution of the carbon powder need not necessarily be uniform throughout the body of the conductive polymer element in all directions. For example, an outer layer of the element may have a uniform distribution of carbon powder but an interior portion may not be conductive. Variations in carbon powder density of distribution in a lengthwise direction preferably are avoided, however, to avoid introducing another variable into the level determinations. Having a uniform distribution of carbon powder throughout the entire conductive polymer element 30 is desirable to provide consistent and reliable level measurements at any level within the container 24.

One example includes polyphthalamide as the polymer material. One example comprises carbon powder in a range from about 0.5% to about 20%. One particular example includes 1.5% carbon powder.

To achieve a uniform distribution of the carbon powder along the length of the polymer element 30, one example manufacturing technique uses an extrusion for extruding the conductive polymer element 30. Extrusion is preferred in one example because it allows for mixing the base polymer material and the carbon powder in a manner that provides a uniform or homogenous distribution of the carbon powder along the length of the conductive polymer element 30.

The conductive polymer element 30 in one example has an electrical resistance that is much higher than an electrical resistance of the fluid 22. In one example, the conductive polymer element has an electrical resistance that is at least 250 Kilo-Ohms. Another example includes an electrical resistance that is approximately 500 Kilo-Ohms. Utilizing such a high electrical resistance allows for making accurate level determinations at a variety of fluid levels within the container 24.

Utilizing such a high resistance measurement element requires a fluid having a sufficient electrical conductivity to achieve meaningful results. One example embodiment is useful for fluids having an electrical conductivity that is at least 100 microsiemens/cm³. Urea is one such fluid.

FIG. 2 schematically illustrates a selected portion of one example controller 40 for selectively powering the conductive polymer element 30. This example includes circuitry that operates as a voltage doubler with a DC component blocking feature that provides only AC electrical energy to the conductive polymer element 30.

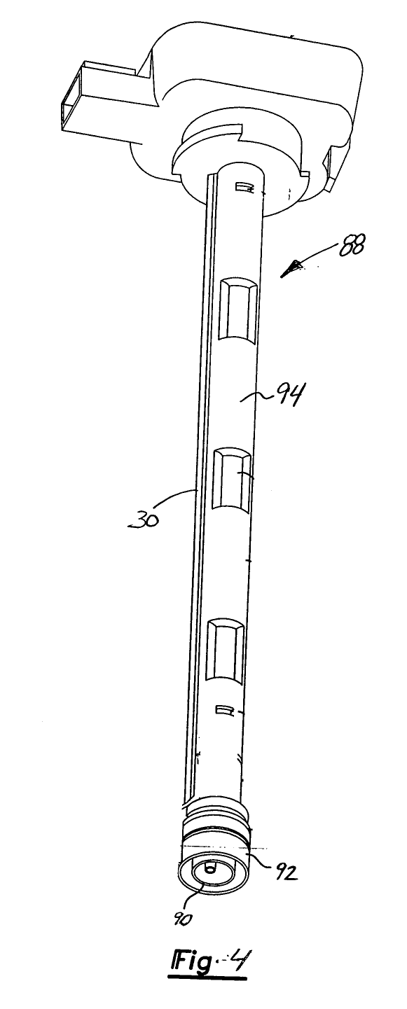

A voltage source 50 and switches 52 and 54 are selectively controlled for energizing the conductive polymer element 30. FIG. 3 shows a timing diagram 56 that corresponds to one example use of the embodiment of FIG. 2. During an idle state shown at A in FIG. 3 an input 58 has a voltage level corresponding to VCC from the voltage source 50 such that the input 58 is high and the switch 52 is turned on. In this condition a capacitive portion 60 is unloaded through the switch 52, which is coupled to ground at 62, and the conductive polymer element 30 which is coupled to ground at 42 through the fluid 22. At the same time, an input 64 is grounded so that the input 64 is low and a boot strap capacitive portion 66 is loaded with a voltage VCC of the voltage supply 50 through a resistive element 68 such that a voltage VG at 70 is equal to the voltage VCC. In this state, the switch 54 is turned off. Another input 72 is grounded such that a capacitive portion 74 is loaded with the voltage VCC minus the voltage across a diode 76 intrinsic to the switch 54. At this stage, a voltage VD at 78 is equal to the difference between the voltage VCC and the voltage drop across the diode 76.

During a loading phase at B in FIG. 3, the input at 64 moves up to a level such as VCC such that the input goes high. At this point, the voltage VG at 70 increases to twice VCC because of the boot strap capacitive portion 66. Under this condition, the switch 54 turns on and the capacitive portion 74 is loaded with the voltage VCC through the switch 54.

The phase C in FIG. 3 corresponds to stimulating or energizing the conductive polymer element 30 for making a level measurement. Initially, the input 58 goes low such that the switch 52 turns off, which disconnects the capacitive portion 60 from ground. At the same time, the input 64 goes low and the voltage VG at 70 drops to VCC. At this point, the switch 54 turns off, which disconnects the voltage VD at 78 from the voltage source 50. At the same time, the input 72 goes high and the voltage VD at 78 increases to twice VCC and that voltage is applied to the conductive polymer element 30 through a pull up resistor 80 and the capacitive portion 60. By doubling the voltage VCC, the example arrangement allows for using a sufficient voltage to make a level determination without requiring a power source having that higher voltage. Another feature of the example arrangement is that the capacitive portion 60 and the switch 52 operate as a DC component blocker such that the conductive polymer element 30 is energized only with AC electric energy. One advantage to the arrangement shown in FIG. 2 is that it is a capacitive voltage doubler that blocks any DC component from the electrical energy provided to the conductive polymer element 30.

After a stabilization delay, a measurement indicating the level of fluid is achieved at an output 82. In one example, the electric output at 82 is a voltage corresponding to a voltage on the conductive polymer element 30. The controller 40 is suitably programmed to correlate such a voltage to a level determination.

The phase shown at D in FIG. 3 corresponds to a return to the idle state.

FIG. 4 shows one example embodiment where the conductive polymer element 30 is incorporated onto a fluid characteristic determining sensor device 88. This example includes capacitive electrodes 90 and 92 near one end of the device, which are useful for making a urea concentration determination regarding the fluid 22. In this example, the electrode 92 is a cathode of the capacitor and operates as the grounded electrode 42 described above with regard to FIG. 1. In one example, the conductive polymer element 30 is overmolded onto a stem portion 94 of the sensor device 88 shown in FIG. 4. In such an example, the polymer material includes a desired amount of carbon and reinforcing material such as glass fibers to provide good moldability and good mechanical stability.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A level sensor useful for determining a level of a conductive fluid within a container, comprising:
a conductive polymer element having a body with a three dimensional exterior surface having a uniform distribution of carbon powder at leas t aloe the exterior surface, the conductive polymer element is adapted to be at least partially immersed in the fluid such that the fluid establishes a conductive path between the conductive element and ground; and
a controller that selectively energizes the conductive polymer element and makes a level determination based upon an electrical output corresponding to a dimension of a portion of the conductive polymer element outside of the fluid.

2. The level sensor of claim 1, wherein the controller energizes the conductive polymer element with a purely AC input.

3. The level sensor of claim 2, wherein the controller comprises a voltage increasing portion and a DC component blocking portion.

4. The level sensor of claim 1, wherein the conductive polymer element comprises a polymer material and carbon powder.

5. The level sensor of claim 4, wherein the conductive polymer element comprises between about 0.5% and about 20% carbon powder.

6. The level sensor of claim 5, wherein the conductive polymer element comprises about 1.5% carbon powder.

7. The level sensor of claim 4, wherein the carbon powder is uniformly distributed along at least a length or the conductive polymer element.

8. The level sensor of claim 4, wherein the conductive polymer comprises polyphthalamide.

9. The level sensor of claim 1, wherein the conductive polymer element has an electrical resistance that is much higher than an electrical resistance of the fluid.

10. The level sensor of claim 9, wherein the conductive polymer element has an electrical resistance that is at least 250 KOhms.

11. The level sensor of claim 10, wherein the conductive polymer element has an electrical resistance that is about 500 KOhms.

12. The level sensor of claim 1, wherein the fluid has an electrical conductivity that is at least 100 microsiemens/cm².

13. The level sensor or claim 1, wherein the fluid comprises urea.

14. The level sensor of claim 1, wherein the conductive polymer element is an extruded piece.

15. A method of determining a level of a conductive fluid within a container, comprising:
providing a conductive polymer element having a body with a three-dimensional exterior surface having a uniform distribution of carbon powder at least along the exterior surface of the three-dimensional body in the container such that at least a portion of the conductive polymer element is immersed in the fluid;
establishing a conductive path between the conductive polymer element and ground through the fluid; and
determining an electrical output from the conductive polymer element that corresponds to a dimension of a portion of the conductive polymer element that is outside of the fluid.

16. The method of claim 15, comprising energizing the conductive polymer element with a purely AC electrical input.

17. The method of claim 15, wherein the conductive polymer element comprises a polymer material and carbon powder.

18. The method of claim 17, wherein the conductive polymer element comprises between about 0.5% and about 20% carbon powder.

19. The method of claim 15, wherein the conductive polymer element has an electrical resistance that is much higher than an electrical resistance of the fluid.

20. The method of claim 15, wherein the fluid comprises urea.

21. The level sensor of claim 1, wherein the carbon powder is uniformly distributed throughout the body in all directions.

22. The method of claim 15, wherein the carbon powder is uniformly distributed throughout the body in all directions.

23. A level sensor useful for determining a level of a conductive fluid within a container, comprising:
a conductive polymer element that is adapted to be at least partially immersed in the fluid such that the fluid establishes a conductive path between the conductive polymer element and ground; and
a controller that selectively energizes the conductive polymer element with a purely AC input and makes a level determination based upon an electrical output corresponding to a dimension of a portion of the conductive polymer element outside of the fluid.

24. The level sensor of claim 23, wherein the controller comprises a voltage increasing portion and a DC component blocking portion.

25. A level sensor useful for determining a level of a conductive fluid within a container, comprising:
a conductive polymer element that is adapted to be at least partially immersed in the fluid such that the fluid establishes a conductive path between the conductive polymer element and ground, wherein the conductive polymer element is an extruded piece; and
a controller that selectively energizes the conductive polymer element and makes a level determination based upon an electrical output corresponding to a dimension of a portion of the conductive polymer element outside of the fluid.
